(19) United States
(12) Patent Application Publication
(10) Pub. No.: US 2019/0202728 A1
(43) Pub. Date: Jul. 4, 2019

(54) MOLD AND METHOD FOR PROCESSING GLASS

(71) Applicant: AAC Technologies Pte. Ltd., Singapore City (SG)

(72) Inventors: Yuqin Yuan, Shenzhen (CN); Bo Xu, Shenzhen (CN); Wei Su, Shenzhen (CN)

(21) Appl. No.: 16/233,412

(22) Filed: Dec. 27, 2018

(30) Foreign Application Priority Data
Jan. 3, 2018 (CN) 201810006527.3

(51) Int. Cl. C03B 23/03

(52) U.S. Cl. CPC C03B 23/0307; C03B 2215/41; C03B 2215/50; C03B 23/0302

(57) ABSTRACT

The present discloses a mold for processing glass includes a concave mold provided with a cavity and a convex mold matched with the concave mold, the concave mold includes an inner wall for forming the cavity in a surrounding manner, the convex mold includes an outer surface, during mold closing, the convex mold extends into the cavity and is spaced from the inner wall of the cavity, a molding space for molding a three-dimensional glass structure is formed by the outer surface, facing the inner wall, of the convex mold and the inner wall of the cavity jointly in a surrounding manner. The present disclosure further discloses a method for processing glass. By the mold and method for processing glass provided by embodiments of the present disclosure, cracking of a three-dimensional glass product in a processing course can be prevented, and the yield is improved.

### CROSS-REFERENCE TO RELATED APPLICATIONS

This application claims the priority benefit of Chinese Patent Applications Ser. No. 201810006527.3 filed on Jan. 3, 2018, the entire content of which is incorporated herein by reference.

### TECHNICAL FIELD

The present disclosure relates to the field of product molding, in particular to a mold for processing glass and a method for processing a glass product.

### BACKGROUND

Along with development of the Internet era, more and more electronic devices come into people's life, such as mobile phones, tablet computers and laptops. Beside requirements on functions, people have higher and higher requirements on the appearance of the electronic devices, and more and more housings of the electronic devices use three-dimensional glass products. In the existing technology, a mold for processing glass is generally used for producing a three-dimensional glass product by hot bending, the mold for processing glass generally includes a concave mold provided with a cavity and a convex mold matched with the concave mold, after mold closing is finished, a gap in a preset shape can be formed between the concave mold and the convex mold in a surrounding manner, thus, the shape of a glass substrate which is in a hot melting state is limited by the gap so as to mold, and then the glass substrate is cooled to form the three-dimensional glass product in the preset shape.

However, the inventor discovers that the following problems exist in the existing technology at least: in a cooling process of a glass product, the glass product may interfere with the convex mold or the concave mold to cause cracking of the glass product, and the yield is low. Therefore, it is desired to provide a new mold for processing glass to solve the foregoing problems.

### BRIEF DESCRIPTION OF THE DRAWINGS

FIG. 1 is an exploded view of a three-dimensional view of a mold for processing glass provided by the present disclosure;

FIG. 2 is an assembly view of a three-dimensional view of the mold for processing glass provided by the present disclosure;

FIG. 3 is a sectional view along a line A-A in FIG. 2; and

FIG. 4 is a flow chart of a method for processing a glass product provided by the present disclosure.

### DETAILED DESCRIPTION

In order to make the objective, technical scheme and advantage of the present disclosure more clear, various embodiments of the present disclosure are further illustrated in detail in combination with the accompanying drawings hereinafter. However, it will be understood by those skilled in the art that lots of technical details are proposed in the various embodiments of the present disclosure so as to enable readers to understand the present disclosure better. Even if the technical details and various variations and modifications based on the various embodiments hereinafter do not exist, the technical scheme as claimed in various claims of the present disclosure can also be realized.

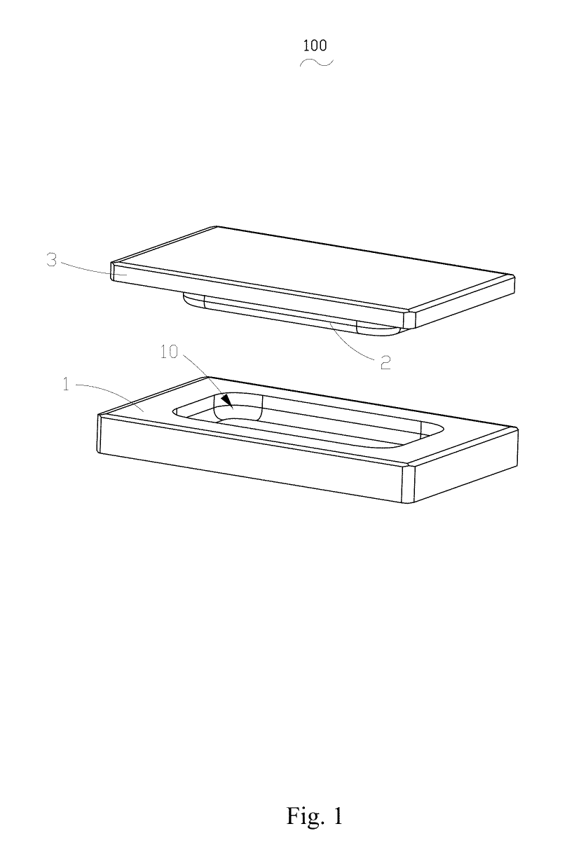

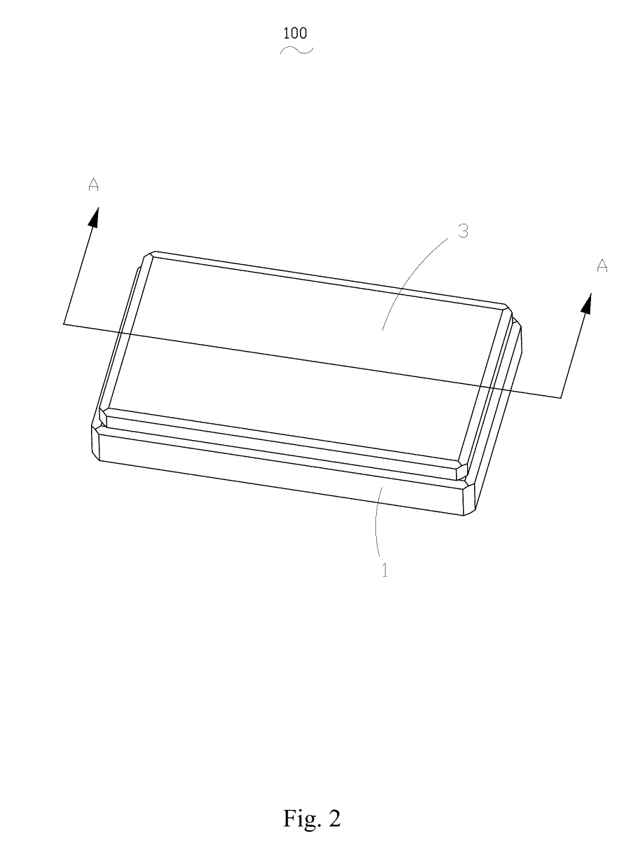

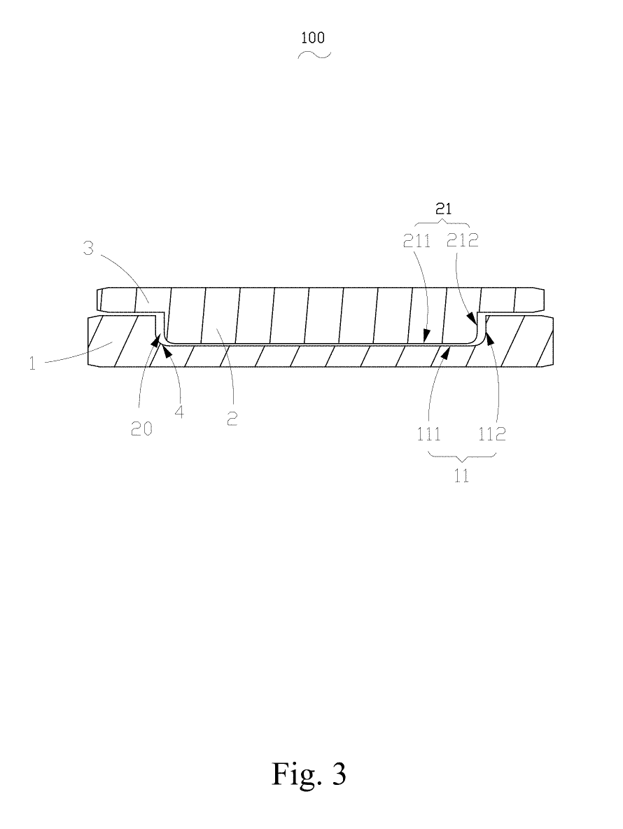

A first embodiment of the present disclosure relates to a mold 100 for processing glass, as shown in FIG. 1 to FIG. 3, the mold 100 for processing glass includes: a concave mold 1 provided with a cavity 10 and a convex mold 2 matched with the concave mold 1, the concave mold 1 includes an inner wall 11 for forming the cavity in a surrounding manner, the convex mold 2 includes an outer surface 21, during mold closing, the convex mold 2 extends into the cavity 10 and is spaced from the inner wall 11 of the cavity 10, a molding space 20 for molding a three-dimensional glass structure is formed by the outer surface 21, facing the inner wall 11, of the convex mold 2 and the inner wall 11 of the cavity 10 jointly in a surrounding manner, the coefficient of thermal expansion of the convex mold 2 is greater than the coefficient of thermal expansion of the glass, and the coefficient of thermal expansion of the concave mold 1 is less than the coefficient of thermal expansion of the glass.

Compared with the existing technology, the embodiment of the present disclosure has the characteristics that the coefficient of thermal expansion of the material of the convex mold 2 is greater than the coefficient of thermal expansion of the glass while the coefficient of thermal expansion of the material of the concave mold 1 is less than the coefficient of thermal expansion of the glass, therefore, in a cooling process of the three-dimensional glass product, the shrinking speed of the convex mold 2 is greater than that of the glass, the shrinking speed of the concave mold 1 is less than that of the glass, the three-dimensional glass product may not interfere with the convex mold 2 or the concave mold 1, and the yield is improved. Meanwhile, during mold opening, the molding size of the convex mold 2 is less than the internal dimension of the three-dimensional glass product, the size of the cavity 10 is greater than the external dimension of the three-dimensional glass product, namely, the size of the molding space 20 is greater than the thickness of the three-dimensional glass product, sides of the three-dimensional glass product can be automatically released from the mold 100 for processing glass, and processing steps are simplified.

It is worth mentioning that the mold 100 for processing glass further includes a base 3, the base 3 is arranged on one side, away from the cavity 10, of the convex mold 2 and is connected to the convex mold 2. The base can be used for supporting and fixing the convex mold, and during mold closing of the mold for processing glass, the convex mold can be fixed on the concave mold through a lock module so as to maintain the relative fixing of the convex mold and the concave mold. The material of the base 3 and the material of the convex mold 2 can be same and can also be different. When the material of the base 3 is the same as that of the convex mold 2, the base 3 and the convex mold 2 can be one integrated structure, during mold closing and fixing of the mold for processing glass, the relative positions of the base 3 and the convex mold 2 may not be changed, it can be ensured that the shape and the size of a gap formed between the concave mold 1 and the convex mold 2 in a surrounding manner are stable and unchanged, and the molding yield of the product is improved favorably. When the material of the base 3 is different from that of the convex mold 2, the convex mold 2 may be detachably fixed on the base 3, it is convenient to replace the convex mold 2 at any time when damaged, moreover, when the material of the base 3 is different from that of the convex mold 2, selection of the material of the base 3 only needs to meet the requirement for the service characteristic and the requirement for the processing characteristic of the base of the mold, strict requirements for the coefficient of expansion are not required, and thus, the degree of freedom of selection of the material of the base 3 is higher.

Specifically, the inner wall 11 includes a bottom wall 111 positioned on the bottom of the cavity 10 and a side wall 112 bending and extending from the bottom wall 111, the outer surface 21 includes a top surface 211 facing the bottom wall 111 and a side surface 212 extending towards the direction away from the bottom wall 111 from the top surface 211; the bottom wall 111, the side wall 112, the top surface 211 and the side surface 212 jointly form the molding space 20 in a surrounding manner. The molding space 20 can be used for limiting the shape of a glass substrate which is in a hot melting state so as to form the glass substrate, and after the glass substrate is cooled, a three-dimensional glass product in a preset shape can be formed.

Preferably, chamfers 4 are respectively arranged at a position where the bottom wall 111 is connected to the side wall 112 and a position where the top surface 211 is connected to the side surface 212. The shapes of the chamfers can be determined according to the shape of a required glass finished product.

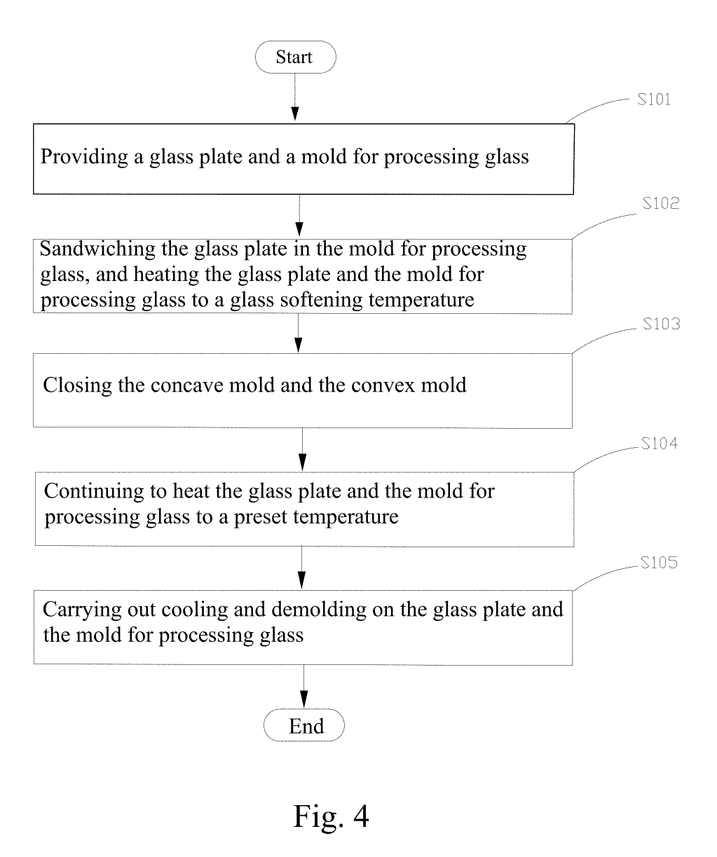

A second embodiment of the present disclosure provides a method for processing a glass product, as shown in FIG. 4, including:

S101: providing a glass plate and a mold 100 for processing glass, where the mold 100 for processing glass is the one disclosed above.

As mentioned above, the mold 100 for processing glass includes: the concave mold 1 provided with the cavity 10 and the convex mold 2 matched with the concave mold 1, the coefficient of thermal expansion of the convex mold 2 is greater than the coefficient of thermal expansion of the glass, and the coefficient of thermal expansion of the concave mold 1 is less than the coefficient of thermal expansion of the glass. It will be understood that the mold generally further includes other elements such as a lock module and a limiting clamp, and since the other elements are not the main focus of the present disclosure, they will not be listed here. Moreover, the material of the concave mold 1 and the material of the convex mold 2 can be selected from any of metal or alloy materials which meet the requirement for the material of the mold for processing glass on the premise of meeting the above-mentioned requirement for the coefficient of thermal expansion.

S102: softening: sandwiching the glass plate between the concave mold 1 and the convex mold 2 of the mold 100 for processing glass, and heating the glass plate and the mold 100 for processing glass to a glass softening temperature.

Specifically, in step S102, the softening temperature is generally 700° C. or above, and preferably is 700° C., in the process, the mold 100 for processing glass is in a mold opening state, the convex mold 2 has not been extended into the cavity 10 yet, and the glass plate is in a hardened state, and is sandwiched between the convex mold 2 and the concave mold 1 to make preparations for follow-up mold closing.

S103: mold closing: closing the concave mold 1 and the convex mold 2.

In the process, the glass plate is in a softened state, and along with mold closing of the convex mold 2 and the concave mold 1, the glass plate is subjected to hot bending under the pressure of mold closing, and is finally limited in the molding space 20 formed by the concave mold 1 and the convex mold 2 during mold closing.

S104: reheating: continuing to heat the glass plate and the mold 100 for processing glass to a preset temperature which is 720° C. to 780° C.

Because the coefficient of thermal expansion of the convex mold 2 is greater than the coefficient of thermal expansion of the glass and the coefficient of thermal expansion of the concave mold 1 is less than the coefficient of thermal expansion of the glass, in a process of continuing heating the glass plate and the mold 100 for processing glass, the expansion speed of the convex mold 2 is greater than that of the glass, the expansion speed of the concave mold 1 is less than that of the glass, the mold 100 for processing glass applies a certain pressure to sides of the glass, so that the glass is more easily molding with hot bending.

S105: cooling: cooling the glass plate and the mold for processing glass to the room temperature;

Particularly, the cooling process is divided into two stages, in the first stage, the glass turns into a hardened state from the softened state, at the moment, the glass plate clings to the convex mold 2 and the concave mold 1, and the molding size of the glass is determined by the gap between the convex mold 2 and the concave mold 1; in the second stage, the formed three-dimensional glass product shrinks according to its coefficient of thermal expansion, as the coefficient of thermal expansion of the convex mold 2 is greater than the coefficient of thermal expansion of the glass, the shrinking speed of the convex mold 2 is greater than that of the glass, the size of the convex mold 2 can be decreased to be smaller than the size of the cavity of the three-dimensional glass product, therefore, the convex mold 2 is automatically separated from the three-dimensional glass product, meanwhile, the thermal expansion of the concave mold 1 is smaller than the thermal expansion of the glass, the shrinking speed of the concave mold 1 is less than that of the glass, the size of the cavity 10 of the concave mold 1 is greater than the external dimension of the three-dimensional glass product, and the concave mold 1 will also be separated from the three-dimensional glass product automatically. Thus, in the cooling process, the three-dimensional glass product may not be pressed by any components in the mold 100 for processing glass, and cracking of the three-dimensional glass product is prevented; and meanwhile, the three-dimensional glass product is automatically separated from the convex mold 2 and the concave mold 1 in the cooling process.

Demolding: separating the glass plate from the concave mold and the convex mold to finish demolding.

Those ordinary skilled in the art can understand that the various foregoing embodiments are specific embodiments for implementing the present disclosure, and in practical application, various changes can be made in forms and details without departing from the spirit and scope of the present disclosure.

1. A mold for processing glass, comprising: a concave mold provided with a cavity and a convex mold matched with the concave mold, the concave mold comprising an inner wall for forming the cavity in a surrounding manner, the convex mold comprising an outer surface, wherein during mold closing, the convex mold extends into the cavity and is spaced from the inner wall of the cavity, a molding space for molding a three-dimensional glass structure is formed by the outer surface, facing the inner wall, of the convex mold and the inner wall of the cavity jointly in a surrounding manner, the coefficient of thermal expansion of the convex mold is greater than the coefficient of thermal expansion of the glass, and the coefficient of thermal expansion of the concave mold is less than the coefficient of thermal expansion of the glass.

2. The mold for processing glass according to claim 1, wherein the mold for processing glass further comprises a base, and the base is fixed on one side, away from the cavity, of the convex mold and is connected to the convex mold.

3. The mold for processing glass according to claim 2, wherein a material of the base is same as that of the convex mold, and the base and the convex mold are formed as one integrated structure.

4. The mold for processing glass according to claim 2, wherein a material of the base is different from that of the convex mold, and the convex mold is detachably fixed on the base.

5. The mold for processing glass according to claim 1, wherein the inner wall of the concave mold comprises a bottom wall positioned on the bottom of the cavity and a side wall bending and extending from the bottom wall, the outer surface of the convex mold comprises a top surface facing the bottom wall and a side surface extending towards the direction away from the bottom wall from the top surface, and the bottom wall, the side wall, the top surface and the side surface form the molding space jointly in a surrounding manner.

6. The mold for processing glass according to claim 2, wherein chamfers are respectively arranged at a position where the bottom wall is connected to the side wall and a position where the top surface is connected to the side surface.

7. A method for processing glass, comprising:
providing a glass plate and a mold for processing glass, wherein the mold for processing glass is the mold for processing glass according to claim 1;
softening: sandwiching the glass plate between a concave mold and a convex mold of the mold for processing glass, and heating the glass plate and the mold for processing glass to a glass softening temperature;
mold closing: closing the concave mold and the convex mold;
cooling: cooling the glass plate and the mold for processing glass to room temperature; and
demolding: separating the glass plate from the concave mold and the convex mold to finish demolding.

8. The method for processing glass according to claim 7, wherein the cooling process comprises: cooling the glass plate, the concave mold and the convex mold until the glass plate is hardened, and then cooling the glass plate, the concave mold and the convex mold to the room temperature.

9. The method for processing glass according to claim 7, wherein after the mold closing process is finished, the glass plate, the concave mold and the convex mold are further heated to a preset temperature, and the preset temperature is 720° C. to 780° C.

10. A method for processing glass, comprising:
providing a glass plate and a mold for processing glass, wherein the mold for processing glass is the mold for processing glass according to claim 2;
softening: sandwiching the glass plate between a concave mold and a convex mold of the mold for processing glass, and heating the glass plate and the mold for processing glass to a glass softening temperature;
mold closing: closing the concave mold and the convex mold;
cooling: cooling the glass plate and the mold for processing glass to room temperature; and
demolding: separating the glass plate from the concave mold and the convex mold to finish demolding.

11. The method for processing glass according to claim 10, wherein the cooling process comprises: cooling the glass plate, the concave mold and the convex mold until the glass plate is hardened, and then cooling the glass plate, the concave mold and the convex mold to the room temperature.

12. The method for processing glass according to claim 10, wherein after the mold closing process is finished, the glass plate, the concave mold and the convex mold are further heated to a preset temperature, and the preset temperature is 720° C. to 780° C.
